(19) United States
(12) Patent Application Publication
(10) Pub. No.: US 2016/0321411 A1
(43) Pub. Date: Nov. 3, 2016

(54) SYSTEMS AND METHODS FOR PROVIDING CONSUMER DISCOUNTS ON COMPOUNDED PRESCRIPTION MEDICATIONS

(71) Applicant: Jay Wiley, West Monroe, LA (US)

(72) Inventor: Jay Wiley, West Monroe, LA (US)

(21) Appl. No.: 15/144,260

(22) Filed: May 2, 2016

Related U.S. Application Data
(60) Provisional application No. 62/155,641, filed on May 1, 2015.

(51) Int. Cl. G06F 19/00; G06Q 40/08; G06Q 50/22; G06Q 10/10

(52) U.S. Cl. CPC G06F 19/328; G06Q 10/10; G06Q 40/08; G06Q 50/22; G06F 19/3462

(57) ABSTRACT

Embodiments are directed to providing the capability for a pharmacy to submit a claim for a discount to a claims processing device or system for compound ingredients, thereby incentivizing the pharmacy and drug manufacturers to participate in the discount program. In order to confirm that a pharmacy is eligible for a particular discount, the manufacturer may require that the pharmacy use one or more ingredients supplied by that manufacturer in its compounds, as applicable. Thus, the manufacturer may increase its overall profit by selling additional, non-discounted ingredients to the pharmacy, while improving its market share by offering the discounts on other ingredients.

### CROSS-REFERENCE TO RELATED APPLICATIONS

This application claims priority to U.S. Provisional Patent Application No. 62/155,641, filed May 1, 2015, entitled “Systems and Methods for Providing Consumer Discounts on Compounded Prescription Medications,” the contents of which are hereby incorporated by reference in its entirety.

### BACKGROUND

With the increasing cost of drugs, customers as a whole are a highly price-sensitive group. Indeed, studies have shown that the likelihood of a customer purchasing drugs is strongly correlated with the customer's out-of-pocket amount for the drugs. As an example, customers may select one drug over another based upon a lower co-pay amount. As another example, a customer may select (or request a prescription for) a drug that is covered by one or more third-party payers (e.g., an insurance plan) as opposed to a drug that is not covered by the third-party payers.

Given that customers are a price-sensitive group, it is not unusual to expect that customers may stop taking a drug or may switch to a cheaper drug if the customer's out-of-pocket amount increases. The customer's out-of-pocket amount may increase, for example, where the employer changes the copayment required for a drug that is covered under a preferred status under its insurance plan. Likewise, a customer's out-of-pocket amount may increase where an insurer or other third-party payer changes the pharmaceutical manufacturers and/or drugs that are preferred. In these situations, the pharmaceutical manufacturers may lose control over the customer's out-of-pocket amount for its drugs, thereby risking that the customer will stop purchasing its drug products.

Attempts have been made to provide a consumer with a discount for a specific drug. For example, U.S. Pat. No. 8,050,943 entitled “Systems and Methods for Retaining or Shifting Prescription Market Share,” the content of which is hereby incorporated by reference in its entirety, is directed to providing a consumer with a manufacturer discount for a specific drug, thereby shifting market share to a specific manufacturer offering one or more discounts. However, these discounts are directed to single ingredient drugs, and are not applicable to compounded drugs or pharmaceuticals.

### SUMMARY

The present disclosure relates to providing consumer discounts for prescription drugs and medications. More specifically, the present disclosure relates to providing consumer discounts for compounded prescription drugs and medications.

In an embodiment, a system provides a discount for compound ingredients of a compounded drug prescribed to a patient. The system comprises: a claims processing device comprising one or more processors and modules, the claims processing device configured to connect with a switch provider to receive and transmit data relating to a claim for the discount for compound ingredients of the compounded drug, the one or more processors and modules configured to: determine discount sponsor eligibility for the claim; determine if one or more of the compound ingredients are eligible for the discount from an eligible discount sponsor; and determine payment rules and the discount for eligible compound ingredients from the eligible discount sponsor. The switch provider transmits the claim to the claims processing device and transmits the one or more determinations from the claims processing device to a discount sponsor that submitted the claim.

In an embodiment, the claims processing device directly connects with the switch provider.

The system further comprises, according to an embodiment, a network configured to connect the switch provider and the claims processing device. In an embodiment, the network is further configured to connect to the discount sponsor to receive and transmit data relating to the claim.

The system further comprises, according to an embodiment, one or more data storage devices configured to store data related to discount sponsors and compound ingredients, the data accessible to the claims processing device.

In an embodiment, the system further comprises a prescription benefits manager device comprising one or more processors and modules configured to determine third-party payer information related to the claim. The prescription benefits manager device is integrated with the claims processing device, in an embodiment.

In an embodiment, the determination of discount sponsor eligibility for the claim comprises determining if the discount sponsor is actively listed on an active provider database.

In an embodiment, the determination of eligible compound ingredients comprises: determining if a compound code is valid; and if the compound code is valid, analyzing each compound product identifier associated with a respective compound ingredient of the compounded drug to determine if at least one compound ingredient is an eligible ingredient.

According to another embodiment, the determination of payment rules and the discount for eligible compound ingredients from the eligible discount sponsor comprises: determining if one or more of payment information and benefit information qualifies the patient for the discount; and if the patient is qualified for the discount, analyzing the claim to determine patient payment responsibility comprising the payment rules and an amount of the discount.

In an embodiment, a method provides a discount for compound ingredients of a compounded drug prescribed to a patient. The method comprises: determining, by a claims processing device comprising one or more processors and modules, discount sponsor eligibility for a claim for the discount for compound ingredients of the compounded drug; determining, by the claims processing device, if one or more of the compound ingredients are eligible for the discount from an eligible discount sponsor; and determining, by the claims processing device, payment rules and the discount for eligible compound ingredients from the eligible discount sponsor. The claims processing device is configured to connect with a switch provider to receive and transmit data relating to the claim; the switch provider transmits the claim to the claims processing device and transmits the one or more determinations from the claims processing device to a discount sponsor that submitted the claim.

### BRIEF DESCRIPTION OF THE FIGURES

The foregoing and other aspects of the present invention are best understood from the following detailed description when read in connection with the accompanying drawings. For the purpose of illustrating the invention, shown in the drawings are embodiments that are presently preferred, it being understood, however, that the invention is not limited to the specific instrumentalities disclosed. Included in the drawings are the following Figures:

FIG. 1 depicts a block diagram of an illustrative system for offering and providing one or more discounts to a consumer, according to an embodiment;

FIGS. 2A and 2B are flow diagrams illustrating exemplary data flow for offering and providing one or more discounts to a consumer, according to embodiments;

FIGS. 3-5 depict sample processes for determining eligibility and providing a discount to a consumer, according to an embodiment; and

FIG. 6 depicts a block diagram of illustrative internal hardware that may be used to contain or implement program instructions according to various embodiments.

### DETAILED DESCRIPTION

The present disclosure relates generally to systems and methods for determining eligibility for and, if eligible, providing a discount to a consumer purchasing a compounded medication from a pharmacy or other similar provider. As used herein, a compound or compounded drug refers to a drug containing two or more unique and distinct ingredients. Existing pharmaceutical discount plans, such as those described above, are directed to single ingredient drugs as previously existing standards were directed to claims and discount processing for a single ingredient drug. However, with recent standards changes, such as National Council for Prescription Drug Programs (NCPDP) standard D.0, compounded drugs can be accurately reflected in claim processing. Prior to the D.0 standard, when billing for a compound, a pharmacy would enter each ingredient in the compound into the claim processing software, but the then-existing standard (3.X) did not support transmission of all compound element information. Rather, the then-existing standard only supported transmission of a single data element representing a product segment. Such an arrangement worked for non-compounded drugs, but did not provide a means for a pharmacy to claim individual ingredients contained within compounded drugs.

The present disclosure utilizes improvements made in the D.0 standard to provide for accurate compounded drug claiming. For example, the D.0 standard includes a segment in the claim data for listing each individual ingredient in a compound. Such a data listing provides the capability for a pharmacy to submit a claim for a discount to a claims processing device or system for compound ingredients, thereby incentivizing the pharmacy and drug manufacturers to participate in the discount program.

The processes and techniques as described herein may be applied to the pharmaceutical industry to both increase consumer loyalty to a particular pharmacy (e.g., a pharmacy that participates in the discount program and provides maximized discounts to its patrons) as well as to the compounded drug ingredients made available from pharmaceutical companies. For example, a pharmaceutical company may provide a discount on a high margin ingredient, thereby still receiving a profit on any compound made with that ingredient. However, in order to confirm that a pharmacy is eligible for a particular discount, the manufacturer may require that the pharmacy use one or more ingredients supplied by that manufacturer in its compounds, as applicable. Thus, the manufacturer may increase its overall profit by selling additional, non-discounted ingredients to the pharmacy, while improving its market share by offering the discounts on other ingredients.

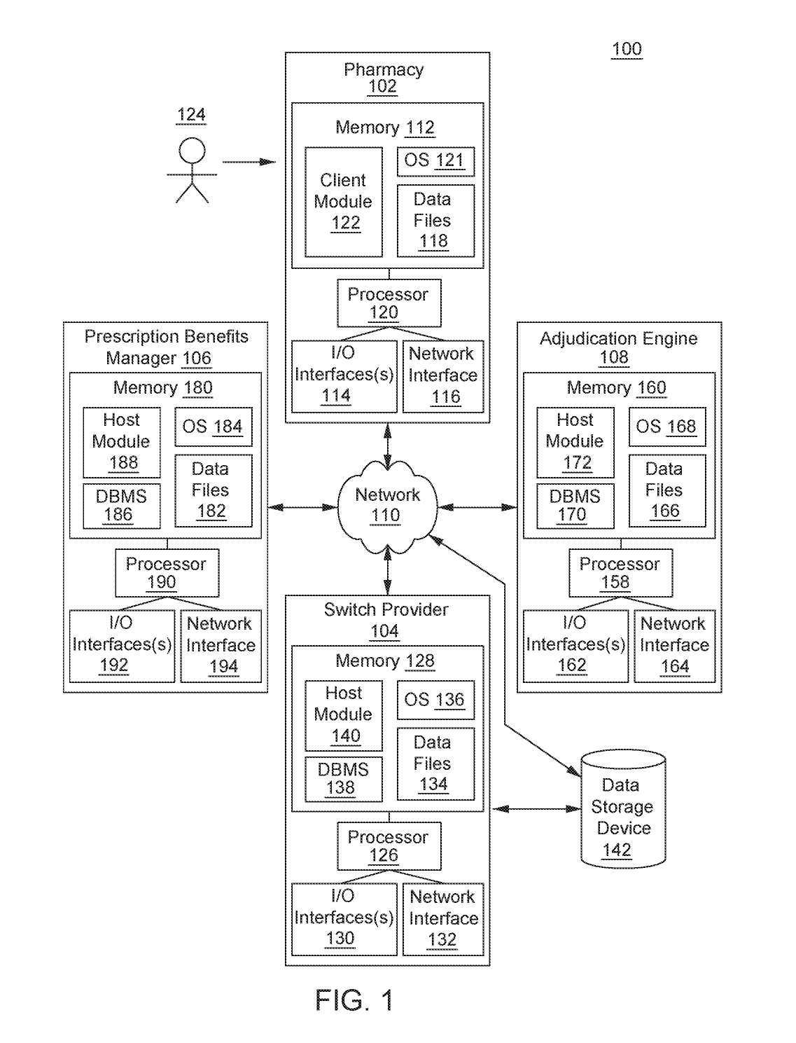

FIG. 1 illustrates an exemplary system 100 that allows a pharmaceutical manufacturer to retain or shift its drug market share in the 100% co-pay marketplace (e.g., a discount program) and the funded (e.g., insurance plan, retirement benefits plan, etc.) marketplace. In particular, the system 100 may include at least one pharmacy computer 102, at least one switch provider 104, a pharmaceutical (or prescription) benefits manager (PBM) 106, and an adjudication engine 108, which are each configured for accessing and reading associated computer-readable media having stored thereon data and/or computer-executable instructions for implementing the various methods of the invention. Generally, the adjudication engine 108 may determine benefits, coverage, and/or extent of coverage for one or more claims. According to one embodiment of the invention, the adjudication engine 108 and the PBM 106 may be associated and integrated with one another. The PBM 106 may generally include any third-party payer such as insurance companies, a retirement benefits plan, and the like. According to another embodiment of the invention, the adjudication engine 108 may also include providers of 100% co-pay plans such as discount programs. According to yet another embodiment of the invention, the adjudication engine 108 may be the switch provider 104.

Generally, network devices and systems, including the one or more pharmacy computers 102, switch providers 104, PBMs 106, and adjudication engines 108 have hardware and/or software for transmitting and receiving data and/or computer-executable instructions over a communications link and a memory for storing data and/or computer-executable instructions. These network devices and systems may also include a processor for processing data and executing computer-executable instructions, as well as other internal and peripheral components that are well known in the art. As used herein, the term “computer-readable medium” describes any form of memory or a propagated signal transmission medium. Propagated signals representing data and computer-executable instructions are transferred between network devices and systems.

Still referring to FIG. 1, a pharmacy computer 102 may be in communication with the switch provider 104 via a network 110, which as described below can include one or more private and public networks, including the Internet. Likewise, the switch provider 104 may also be in communication with an adjudication engine 108 via the network 110 and with a PBM 106 via the network 110. According to an embodiment of the invention, the pharmacy computer 102, the switch provider 104, the PBM 106, and the adjudication engine 108 may be in direct communication with each other. Each of these components—the pharmacy computer 102, the switch provider 104, the PBM 106, the adjudication engine 108, and the network 110—will now be discussed in turn below.

First, the pharmacy computer 102 may be any processor-driven device, such as a personal computer, laptop computer, handheld computer, and the like. In addition to having a processor 120, the pharmacy computer 102 may further include a memory 112, input/output (“I/O”) interface(s) 114, and a network interface 116. The memory 112 may store data files 118 and various program modules, such as an operating system (“OS”) 121 and a client module 122. The client module 122 may be an Internet browser or other software, including a dedicated program, for interacting with the switch provider 104. For example, a user such as a pharmacist or other pharmacy employee may utilize the client module 122 in preparing and providing a drug request or order to the switch provider 104 for processing. The pharmacy computer 102 may also utilize the client module 122 to retrieve or otherwise receive data from the switch provider 104, including application or availability of a voucher, coupon, payment and/or discount, as described herein, for the drug request or order.

Still referring to the pharmacy computer 102, the I/O interface(s) 114 facilitate communication between the processor 120 and various I/O devices, such as a keyboard, mouse, printer, microphone, speaker, monitor, bar code readers/scanners, RFID readers, and the like. The network interface 116 may take any of a number of forms, such as a network interface card, a modem, a wireless network card, and the like. These and other components of the pharmacy computer 102 will be apparent to those of ordinary skill in the art and are therefore not discussed in more detail herein.

Similar to the pharmacy computer 102, the switch provider 104 may include any processor-driven device that is configured for receiving, processing, and fulfilling requests or claims from the pharmacy computer 102 related to pharmacy, benefits, and/or discount transactions, including coupons and/or vouchers described herein. The switch 104 may therefore include a processor 126, a memory 128, input/output (“I/O”) interface(s) 130, and a network interface 132. The memory 128 may store data files 134 and various program modules, such as an operating system (“OS”) 136, a database management system (“DBMS”) 138, and the host module 140. According to an embodiment of the invention, the data files 134 may store history records or tables associated with one or more claim submissions. The data files 134 may also store routing tables for determining the subsequent transmission of received claim submission. For example, these routing tables may determine that particular claim submissions are associated with certain PBMs, and therefore specify a particular adjudication engine 108 to which to route the claim submissions. The host module 140 initiates, receives, processes, and responds to requests from the respective client module 122 of pharmacy computer 102, and further initiates, receives, processes, and responds to requests from the respective host modules 172 of the adjudication engine 108. The switch provider 104 may include additional program modules for performing other pre-processing or post-processing methods described herein. Those of ordinary skill in the art will appreciate that the switch provider 104 may include alternate and/or additional components, hardware or software. According to an embodiment of the invention, the switch provider 104 may be similar to the host server described in U.S. patent application Ser. No. 10/439,422, filed May 16, 2003, and entitled “Systems and methods for verifying and editing electronically transmitted claim content.” The foregoing application, which was published on Apr. 22, 2004 as U.S. Publication No. 2004/0078247, is incorporated herein by reference in its entirety.

As illustrated in FIG. 1, the switch provider 104 may include or be in communication with at least one data storage device 142, or databases. If the switch provider 104 includes the data storage device 142, then the data storage device 142 could also be part of the memory 128. The data storage device 142 and/or memory 128 may store, for example, program rules and transaction records (e.g., history records) and/or discounts (e.g., coupons, vouchers, etc.) associated with the drug requests and orders. Although a single data storage device 142 is referred to herein for simplicity, those skilled in the art will appreciate that multiple physical and/or logical data storage devices or databases may be used to store the above-mentioned data. For security and performance purposes, the switch provider 104 may have a dedicated connection to the data storage device 142. However, the switch provider 104 may also communicate with the data storage device 142 via a network 110, as shown. In other embodiments of the invention, the switch provider 104 may include the data storage device 142 locally. The switch provider 104 may also otherwise be part of a distributed or redundant database management system (“DBMS”).

The PBM 106 may include any processor-driven device that is configured for receiving, processing, and fulfilling requests from the switch provider 104 related to the pharmacy, benefits, and/or discount transactions, including coupons and/or vouchers described herein. The PBM 106 may therefore include a processor 190, a memory 180, input/output (“I/O”) interface(s) 192, and a network interface 194. The memory 180 may store data files 182 and various program modules, such as an operating system (“OS”) 184, a database management system (“DBMS”) 186, and a host module 188. The host module 188 may initiate, receive, process, and respond to requests from host module 140 of the switch provider 104. The PBM 106 may include additional program modules for performing other pre-processing or post-processing methods described herein. Those of ordinary skill in the art will appreciate that the PBM 106 may include alternate and/or additional components, hardware or software.

Similarly, the adjudication engine 108 may include any processor-driven device that is configured for receiving, processing, and fulfilling requests from the switch provider 104 related to the pharmacy, benefits, and/or discount transactions. The adjudication engine 108 may therefore include a processor 158, a memory 160, input/output (“I/O”) interface(s) 162, and a network interface 164. The memory 160 may store data files 166 and various program modules, such as an operating system (“OS”) 168, a database management system (“DBMS”) 170, and the host module 172. The host module 172 may initiate, receive, process, and respond to requests from host module 140 of the switch provider 104. The adjudication engine 108 may include additional program modules for performing other pre-processing or post-processing methods described herein. Those of ordinary skill in the art will appreciate that the adjudication engine 108 may include alternate and/or additional components, hardware or software.

The network 110 may include any telecommunication and/or data network, whether public, private, or a combination thereof, including a local area network, a wide area network, an intranet, an internet, the Internet, intermediate hand-held data transfer devices, and/or any combination thereof and may be wired and/or wireless. The network 110 may also allow for real-time, off-line, and/or batch transactions to be transmitted between the pharmacy computer 102 and the switch provider 104. Due to network connectivity, various methodologies as described herein may be practiced in the context of distributed computing environments. Although the pharmacy computer 102 is shown for simplicity as being in communication with the switch provider 104 via one intervening network 110, it is to be understood that any other network configuration is possible. For example, intervening network 110 may include a plurality of networks, each with devices such as gateways and routers for providing connectivity between or among networks 110. Instead of or in addition to a network 110, dedicated communication links may be used to connect the various devices. According to an embodiment, the network 110 may include a network similar to NDCHealth's Intelligent Network.

Those of ordinary skill in the art will appreciate that the system 100 shown in and described with respect to FIG. 1 is provided by way of example only. Numerous other operating environments, system architectures, and device configurations are possible. Accordingly, the invention should not be construed as being limited to any particular operating environment, system architecture, or device configuration.

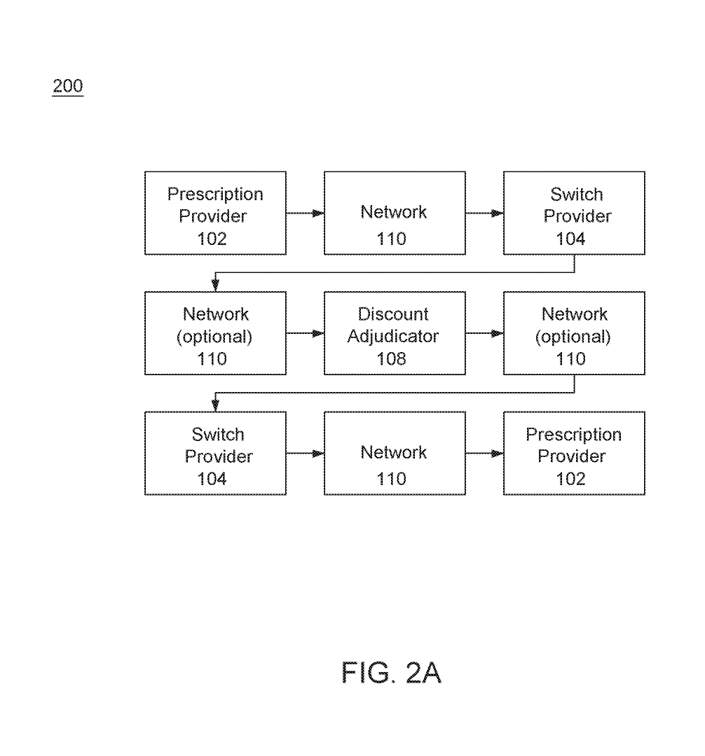

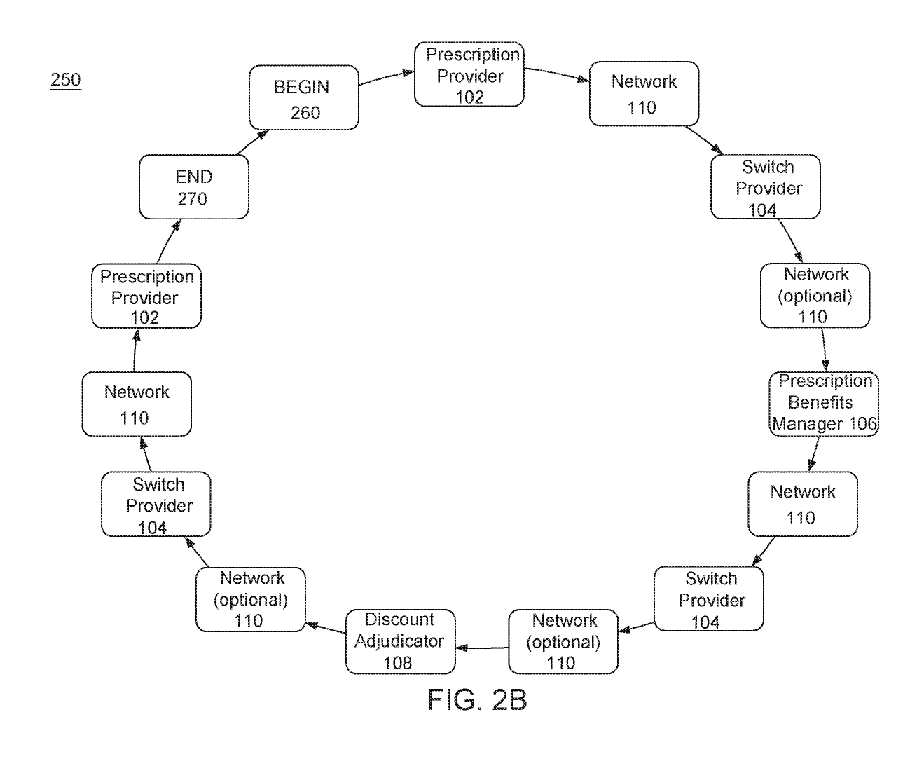

FIGS. 2A and 2B are flow diagrams 200 and 250, respectively, illustrating exemplary data flow for offering and providing one or more discounts to a consumer, according to embodiments provided herein.

The flow diagram 200, with respect to FIG. 2A, provides one example of a data flow in which data (i.e., requests and information related to vouchers, coupons, payments, and/or discounts for a claim) is communicated between the various modules/engines. As shown, a prescription provider (i.e., pharmacy) 102 submits, via a network 110, a request to a switch provider 104. The switch provider 104 transmits, either via the network 110 or via a direct connection, the request to discount adjudicator 108. Via the network 110 or via a direction connection, the discount adjudicator 108 transmits a determination related to the request to the switch provider 104. The switch provider 104 then utilizes the network 110 to transmit the determination to the prescription provider 102.

The flow diagram 250, with respect to FIG. 2B, provides yet another example of a data flow in which data (i.e., requests and information related to vouchers, coupons, payments, and/or discounts) is communicated between the various modules/engines. The flow diagram 250 incorporates a PBM 106. The data flow begins at 260. A prescription provider (i.e., pharmacy) 102 submits, via a network 110, a request to a switch provider 104. The switch provider 104 transmits, either via the network 110 or via a direct connection, the request to the PBM 106. The PBM 106 transmits, either via the network 110 or via a direct connection, a determination related to third-party payer information to the switch provider 104. The switch provider 104 transmits, either via the network 110 or via a direct connection, the request and the determination made by the PBM 106 to discount adjudicator 108. Via the network 110 or via a direction connection, the discount adjudicator 108 transmits a determination related to the request to the switch provider 104. The switch provider 104 then utilizes the network 110 to transmit the one or more determinations to the prescription provider 102. The data flow then ends at 270.

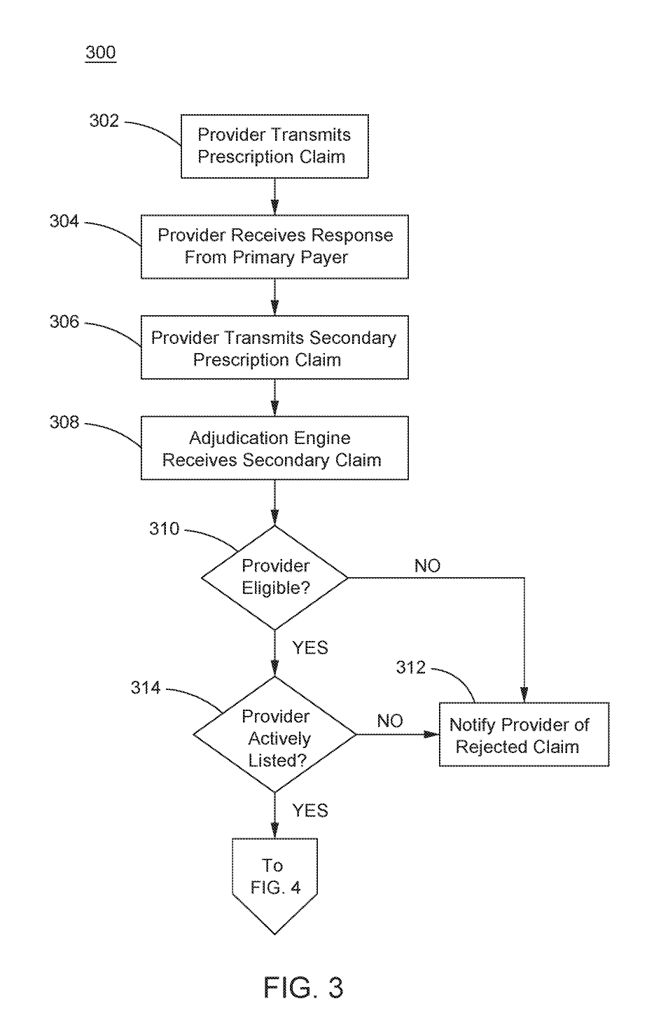

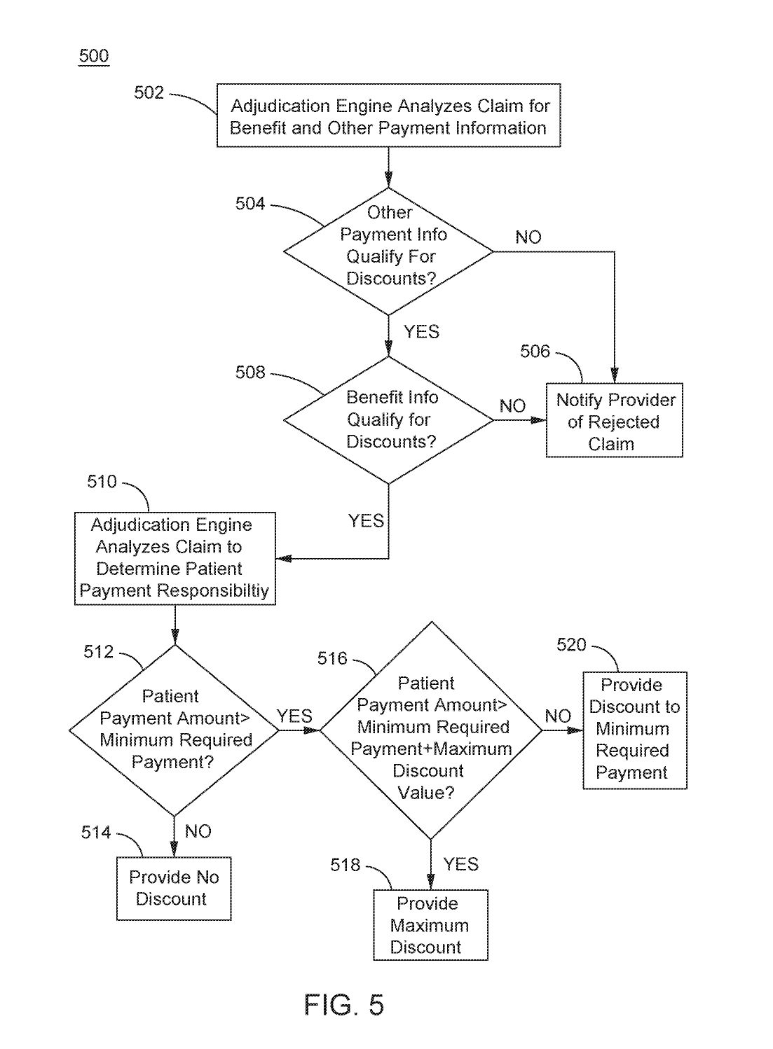

As discussed above with respect to FIGS. 1, 2A, and 2B, embodiments of the invention can assist pharmaceutical manufacturers in retaining or shifting their market share for particular drugs. The operation of embodiments of the invention will now be described below with reference to FIGS. 3-5. FIGS. 3-5 illustrate sample processes for determining provider eligibility (FIG. 3), determining overall claim eligibility (FIG. 3), and processing payment (FIG. 5). It should be noted, however, that the processes as illustrated in FIGS. 3-5, and described herein, are shown by way of example only and may be altered based upon implementation of the consumer discount system and method as described herein. Similarly, the processes as shown in FIGS. 3-5 may be altered as a result of changes to industry standards, as applicable, and are meant only for illustrative and discussion purposes.

FIG. 3 illustrates a sample process 300 for determining provider eligibility for a submitted claim. For example, the process as illustrated in FIG. 3 and described herein determines whether a pharmacy submitting a claim on behalf of a consumer is eligible to receive a discount for the consumer from a manufacturer, a third party payer (e.g., a consumer's supplemental insurer), or another payer.

Initially, a provider such as a pharmacy transmits 302 a prescription claim to a patient's primary payer (e.g., a patient's insurance company) to determine patient eligibility and payment information such as required prescription co-pay amount for that patient. Typically, when entering prescription information into the related software, the software automatically parses the prescription information and populates the various headers and data fields of an electronic claim form appropriately. This electronic claim form may then be submitted to the primary payer. The provider may receive 304 a response from the primary payer indicating that the patient is a member of that, for example, insurance company and has a certain co-pay amount. The provider may then transmit 306 a secondary claim to a coupon or discount vendor. It should be noted that, absent a primary payer (e.g., for an uninsured patient), the process as shown in FIG. 3 may start with the provider transmitting 306 the secondary claim to the discount vendor as the primary claim.

An adjudication engine at the discount vendor may receive 308 the secondary claim and process the claim accordingly. As described above, the claim may be formatted according to the NCPDP D.0 standard (or the then-current standard). The adjudication engine may then determine 310 whether the provider is eligible for participation in the discount program. For example, the adjudication engine may examine a specific service provider ID field in the claim to identify whether the provider has correctly submitted a national provider identifier. If the provider has not correctly set this identifier, the adjudication engine may notify 312 the provider that the claim has been rejected. For example, the adjudication engine may transmit an electronic message to the provider indicating why the claim has been rejected.

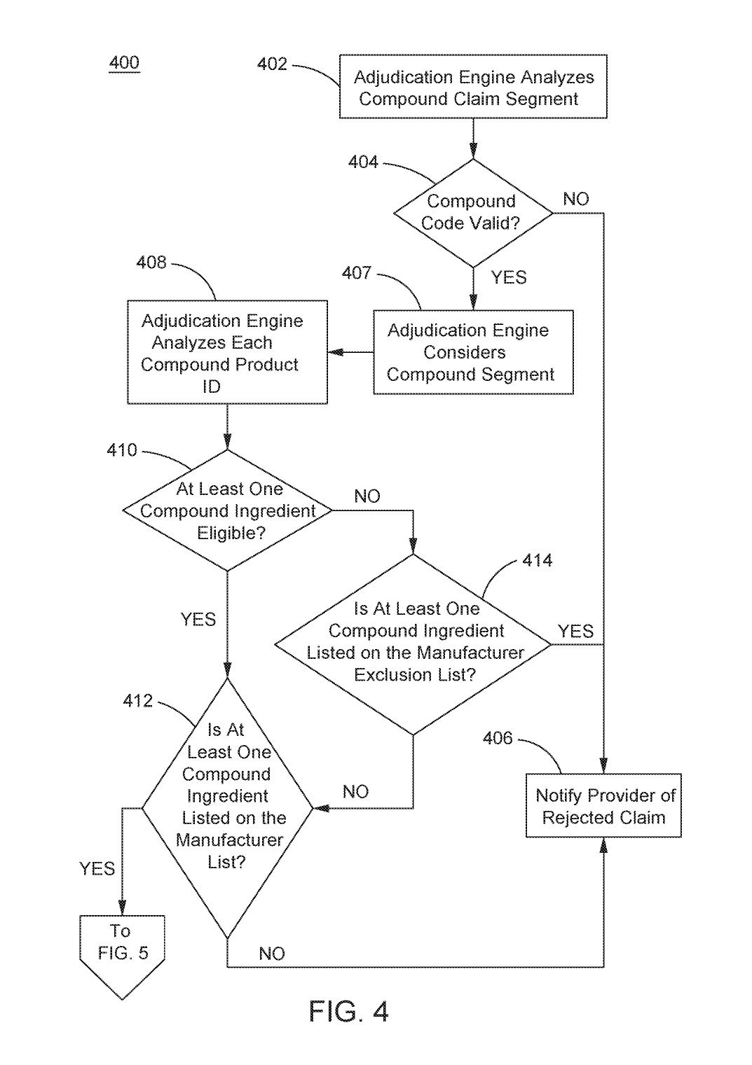

Conversely, if the adjudication engine determines 310 that the provider has correctly indicated its national provider identifier, the adjudication engine may further determine 314 if the provider is actively listed on, for example, an active provider database. In an example, the adjudication engine may store or have access to an active provider database that includes all of the identifying information about each specific contracted provider that belongs to the discount vendor's program. If the adjudication engine determines 314 that the provider's national provider identifier is listed in the active provider database, the process as shown in FIG. 3 continues to FIG. 4. However, if the adjudication engine determines 314 that the provider's national provider identifier is not listed in the active provider database, the adjudication engine may notify 312 the provider of the rejected claim. For example, the adjudication engine may transmit an electronic message to the provider indicating that the provider is not a contracted member of the discount vendor program.

FIG. 4 illustrates a sample process 400 for determining whether the compound information listed in the claim results in discount eligibility for a submitted claim. For example, the process as illustrated in FIG. 4 and described herein determines whether the actual compound ingredients used by the pharmacy submitting the claim are eligible to receive a discount for the consumer from a manufacturer, a third party payer (e.g., a consumer's supplemental insurer), or another payer.

The adjudication engine may analyze 402 the segment of the claim related to the product information. The adjudication engine may then determine 404 whether the included compound code associated with the claimed compound is valid.

If the adjudication engine determines 404 that the compound code is not valid, the adjudication engine may notify 406 the provider that the claim has been rejected. For example, the adjudication engine may transmit an electronic message indicating that the provided compound code is not valid.

If the adjudication engine does determine 404 that the compound code is valid, the adjudication engine may consider 407 the compound segment and analyze 408 each compound product ID utilizing the product's National Drug Code or other identifying mark which may be listed within a national compendia. For example, the adjudication engine may analyze each individual ingredient listed for the compound and determine the manufacturer of each ingredient. The adjudication engine may determine 410 whether at least one ingredient in the compound is eligible for a discount. For example, the adjudication engine may include a database including but not limited to the National Drug Codes (NDCs) and the Generic Product Identifiers (GPIs) for all drugs marketed in the United States. The adjudication engine may also include a Pharmaceutical Ingredient Manufacturer (MFR) database of NDC numbers and their associated GPIs. Each listing in the MFR database may be linked to a manufacturer product that is eligible for the discount program.

To determine 410 if at least one of the compounds is eligible, in one embodiment, the adjudication engine may determine if any of the ingredient GPIs are listed in the MFR database. If there is at least one ingredient GPI listed in the MFR database, the adjudication engine may further determine 412 if the NDC for the compound is listed in the MFR database as well.

Conversely, if the adjudication engine determines 410 that no ingredient GPIs are listed on the MFR database, the adjudication engine may determine 414 whether the compound ingredients are on a MFR exclusion list, e.g., compound ingredients that are specifically excluded from the discount program. The adjudication may make this determination 414 by analyzing whether any compound ingredient NDC is listed on the manufacturer exclusion list. If there is a compound ingredient listed on the manufacturer exclusion list, the adjudication engine may notify 406 the provider that the claim has been rejected. However, if there are no ingredient NDCs on the manufacturer exclusion list, the adjudication engine may further determine 412 if the NDC for the compound is listed in the MFR database.

Such a determination process as that shown in determination 414 provides a way for a manufacturer to incentivize a patient to choose a provider that utilizes the manufacturer's products and stimulates providers to utilize a specific manufacturer's products. For example, if manufacturer A has discounted products 1 and 2, and non-discounted products 3, 4 and 5, manufacturer A may require that the provider uses non-discounted products 3, 4 and 5 in a compound (if such an ingredient is required) in order to obtain the discount for products 1 and 2 to be valid. If a provider uses products 3, 4 and 5 from another manufacturer, then manufacturer A may indicate that such an action is cause for the discount request to be invalid and the claim for a discount to be rejected. Additionally, manufacturer A may provide a list of products that have discounts available for them. If a provider obtains a prescription from a patient that will contain any of the products on manufacturer A's list, the provider must use those products that belong to manufacturer A if a discount is to be provided. Use of any manufacturer other than manufacturer A for those product(s) will result in the discount not being available to the patient.

Referring again to FIG. 4, the adjudication engine may determine 412 whether at least one of the compound ingredients NDCs is listed in the MFR database. If no ingredient NDCs are listed in the MFR database (e.g., the manufacturer has not approved any of those ingredients for a discount), the adjudication engine may notify 406 the provider that no discount has been provided. Conversely, if the adjudication engine determines 412 that at least one compound ingredient NPC is listed in the MFR database, the process may proceed to FIG. 5.

It should be noted that the individual process steps as shown in FIG. 4 may be rearranged or combined as appropriate based upon implementation of the discount method and system as described herein. For example, two or more of the determination steps (e.g., 410, 412 and 414) may be combined or performed simultaneously by the software, and are presented as separate steps by way of example only.

FIG. 5 illustrates a sample process 500 for determining payment rules and a total discount for a submitted and eligible claim (as determined by the processes as shown in FIGS. 3 and 4). For example, the process as illustrated in FIG. 5 and described herein determines what amount the patient is eligible for, what discounts are currently being offered for a compound, and what, if any, portion of the discount is to be applied to the amount the patient owes (e.g., the patient co-pay).

The adjudication engine may analyze 502 the claim for benefit and other payment information associated with the patient such as the patient's co-pay amount or the total amount owed by the patient if their insurance will not pay for the compounded medication. The adjudication engine may determine 504 whether any other payment information (e.g., supplemental insurance or employer payment programs) qualify the patient for a further discount. If the patient does not qualify, the adjudication engine may notify 506 the provider of a rejected claim. However, if the patient does qualify, or if the patient has no other payment information, the adjudication engine may determine 508 if the patient has additional benefits that would disqualify them for a discount.

For example, the adjudication engine may include or have access to a database storing a listing of invalid Benefit Identification Numbers (BIN) for which coupons or other discounts (such as government funded medical or payment plans) are not to be offered. If the adjudication determines 508 that the patient's additional benefit information disqualifies them for a discount, the adjudication engine may notify 506 the provider of a rejected claim. However, if the patient's additional benefit information does qualify, or if the patient does not have additional benefit information, the adjudication engine may analyze 510 the claim to determine the patient's specific payment responsibility for the compounded drug after all additional payers (excluding the discount program) are accounted for.

To determine what, if any, discount amount the patient qualifies for, the adjudication engine may make several additional determinations. For example, the adjudication engine may determine 512 whether the patient's specific payment responsibility is greater than a minimum required payment. For example, a specific manufacturer may require that a patient pay at least a set portion of the total cost of the compounded drug before any discount be applied. The adjudication engine may maintain this minimum payment information, for example, in the MFR database or another associated database. If the patient's specific payment requirement is not greater than the minimum required payment, the adjudication engine indicates that the provider should provide 514 no discount. However, it should be noted that such an occurrence does not indicate that the claim has been rejected. Rather, the patient specific circumstances in this occurrence result in no discount being offered.

Alternatively, if the patient's specific payment amount is greater than the minimum required payment, the adjudication engine may perform an additional discount determination 516. For example, the adjudication engine may determine 516 whether the patient payment amount is greater than the minimum required payment plus the maximum discount value being offered for the compounded drug. If the patient payment amount does exceed the minimum required amount plus the maximum discount value, the adjudication engine may notify the provider to provide 518 the maximum discount to the patient for that compounded drug.

Conversely, if the patient payment amount is not greater than the minimum required payment plus the maximum discount value, the adjudication engine may return 520 a paid response to the vendor with a partial discount equal to the patient pay amount minus the minimum required payment. Thus, the discount covers the difference between the amount previously owed by the patient and the minimum required payment for eligible and qualified patients and compound drugs.

The processes as shown in FIGS. 3-5 are described herein as various components of a single method or process. However, it should be noted that such a description is provided by way of example only. Various steps or process portions as described herein may be separated from the entire process and implemented singularly, reordered, or omitted entirely depending upon the implementation of the processes and techniques as described herein.

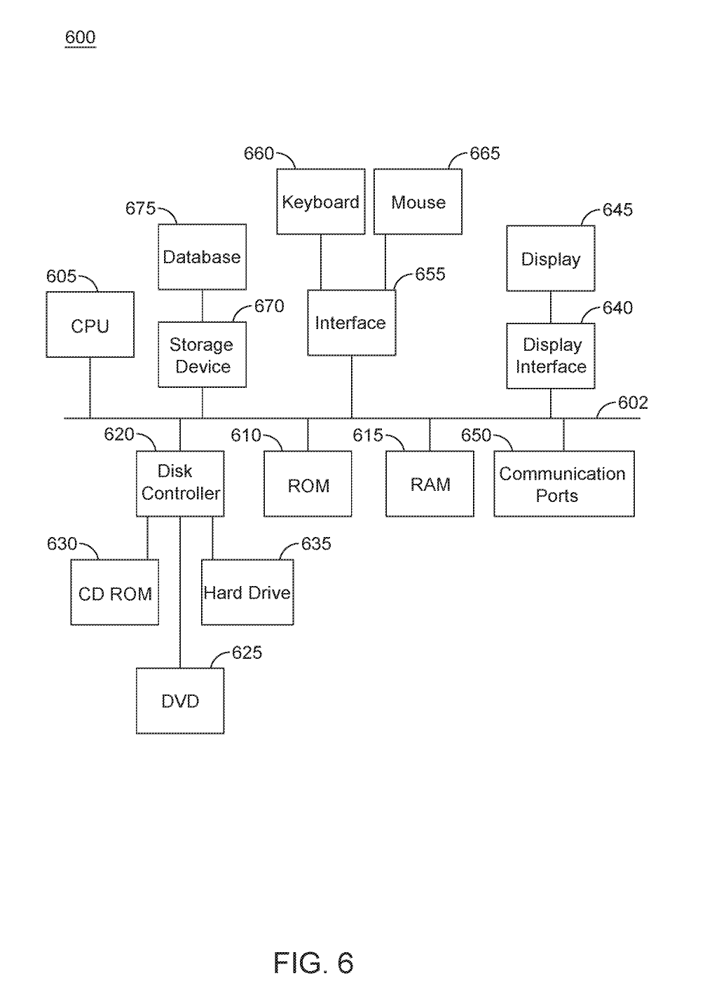

FIG. 6 depicts a block diagram 600 of illustrative internal hardware that may be used to contain or implement program instructions, such as the process steps discussed herein, according to various embodiments. A bus 602 may serve as the main information highway interconnecting the other illustrated components of the hardware. A CPU 605 is the central processing unit of the system, performing calculations and logic operations required to execute a program. The CPU 605, alone or in conjunction with one or more of the other elements disclosed in FIG. 6, is an illustrative processing device, computing device or processing device as such terms are used within this disclosure. Read only memory (ROM) 610 and random access memory (RAM) 615 constitute illustrative memory devices (such as, for example, processing device-readable non-transitory storage media).

A disk controller 620 interfaces with one or more optional memory devices to the system bus 602. These memory devices may include, for example, an external or internal DVD drive 625, a CD ROM drive 630, a hard drive 635, flash memory (not shown), a USB drive (not shown), or the like. As indicated previously, these various drives and controllers are optional devices.

Program instructions, software, or interactive modules for providing the interface and performing any querying or analysis associated with one or more data sets may be stored in the ROM 610 and/or the RAM 615. Optionally, the program instructions may be stored on a tangible computer-readable medium such as a compact disk, a digital disk, flash memory, a memory card, a USB drive, an optical disc storage medium, such as a Blu-ray™ disc, and/or other non-transitory storage media.

An optional display interface 640 may permit information from the bus 602 to be displayed on the display 645 in audio, visual, graphic, and/or alphanumeric format, such as the interface previously described herein. Communication with external devices, such as a print device, may occur using various communication ports 650. An illustrative communication port 650 may be attached to a communications network, such as the Internet, an intranet, or the like.

The hardware may also include an interface 655 which allows for receipt of data from input devices such as a keyboard 660 or other input device 665 such as a mouse, a joystick, a touch screen, a remote control, a pointing device, a video input device and/or an audio input device.

The hardware may also include a storage device 670 such as, for example, a connected storage device, a server, and an offsite remote storage device. Illustrative offsite remote storage devices may include hard disk drives, optical drives, tape drives, cloud storage drives, and/or the like. The storage device 670 may be configured to store data as described herein, which may optionally be stored on a database 675. The database 675 may be configured to store information in such a manner that it can be indexed and searched, as described herein.

The computing device 600 of FIG. 6 and/or components thereof may be used to carry out the various processes as described herein.

Although the present invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

I claim:

1. A system for providing a discount for compound ingredients of a compounded drug prescribed to a patient, the system comprising:
a claims processing device comprising one or more processors and modules, the claims processing device configured to connect with a switch provider to receive and transmit data relating to a claim for the discount for compound ingredients of the compounded drug, the one or more processors and modules configured to:
determine discount sponsor eligibility for the claim;
determine if one or more of the compound ingredients are eligible for the discount from an eligible discount sponsor; and
determine payment rules and the discount for eligible compound ingredients from the eligible discount sponsor;
wherein the switch provider transmits the claim to the claims processing device and transmits the one or more determinations from the claims processing device to a discount sponsor that submitted the claim.

2. The system of claim 1, wherein the claims processing device directly connects with the switch provider.

3. The system of claim 1, further comprising a network configured to connect the switch provider and the claims processing device.

4. The system of claim 3, wherein the network is further configured to connect to the eligible discount sponsor to receive and transmit data relating to the claim.

5. The system of claim 1, further comprising one or more data storage devices configured to store data related to a plurality of discount sponsors and a plurality of compound ingredients, the data accessible to the claims processing device.

6. The system of claim 1, further comprising a prescription benefits manager device comprising one or more processors and modules configured to determine third-party payer information related to the claim.

7. The system of claim 6, wherein the prescription benefits manager device is integrated with the claims processing device.

8. The system of claim 1, wherein the determination of discount sponsor eligibility for the claim comprises determining if the discount sponsor is actively listed on an active provider database.

9. The system of claim 1, wherein the determination of eligible compound ingredients comprises:
determining if a compound code is valid; and
if the compound code is valid, analyzing each compound product identifier associated with a respective compound ingredient of the compounded drug to determine if at least one compound ingredient is an eligible ingredient.

10. The system of claim 1, wherein the determination of payment rules and the discount for eligible compound ingredients from the eligible discount sponsor comprises:
determining if one or more of payment information and benefit information qualifies the patient for the discount; and
if the patient is qualified for the discount, analyzing the claim to determine patient payment responsibility comprising the payment rules and an amount of the discount.

11. A method of providing a discount for compound ingredients of a compounded drug prescribed to a patient, the method comprising:
determining, by a claims processing device comprising one or more processors and modules, discount sponsor eligibility for a claim for the discount for compound ingredients of the compounded drug;
determining, by the claims processing device, if one or more of the compound ingredients are eligible for the discount from an eligible discount sponsor; and
determining, by the claims processing device, payment rules and the discount for eligible compound ingredients from the eligible discount sponsor;
wherein the claims processing device is configured to connect with a switch provider to receive and transmit data relating to the claim; and
wherein the switch provider transmits the claim to the claims processing device and transmits the one or more determinations from the claims processing device to a discount sponsor that submitted the claim.

12. The method of claim 11, wherein the claims processing device directly connects with the switch provider.

13. The method of claim 11, wherein a network is configured to connect the switch provider and the claims processing device.

14. The method of claim 13, wherein the network is further configured to connect to the discount sponsor to receive and transmit data relating to the claim.

15. The method of claim 11, wherein one or more data storage devices are configured to store data related to a plurality of discount sponsors and a plurality of compound ingredients, the data accessible to the claims processing device.

16. The method of claim 11, wherein a prescription benefits manager device comprises one or more processors and modules configured to determine third-party payer information related to the claim.

17. The method of claim 16, wherein the prescription benefits manager device is integrated with the claims processing device.

18. The method of claim 11, wherein determining discount sponsor eligibility for the claim comprises determining if the discount sponsor is actively listed on an active provider database.

19. The method of claim 11, wherein determining if one or more of the compound ingredients are eligible for the discount from the eligible discount sponsor comprises:
determining if a compound code is valid; and
if the compound code is valid, analyzing each compound product identifier associated with a respective compound ingredient of the compounded drug to determine if at least one compound ingredient is an eligible ingredient.

20. The method of claim 11, wherein determining payment rules and the discount for eligible compound ingredients from the eligible discount sponsor comprises:
determining if one or more of payment information and benefit information qualifies the patient for the discount; and
if the patient is qualified for the discount, analyzing the claim to determine patient payment responsibility comprising the payment rules and an amount of the discount.
